(19) United States
(12) Patent Application Publication
(10) Pub. No.: US 2018/0105459 A1
(43) Pub. Date: Apr. 19, 2018

(54) A MULTILAYER COATING

(71) Applicant: AGENCY FOR SCIENCE, TECHNOLOGY AND RESEARCH, Singapore (SG)

(72) Inventors: Goutam Kumar DALAPATI, Singapore (SG); Shijie WANG, Singapore (SG); Dongzhi CHI, Singapore (SG)

(21) Appl. No.: 15/568,456

(22) PCT Filed: Apr. 20, 2016
(86) PCT No.: PCT/SG2016/050183

§ 371 Date: Oct. 20, 2017

(30) Foreign Application Priority Data
Apr. 20, 2015 (SG) 10201503099U

(51) Int. Cl. C03C 17/36; C09D 5/33

(52) U.S. Cl. CPC C03C 17/3681; C09D 5/004; C03C 17/3649; C03C 17/366; C03C 17/3642

(57) ABSTRACT

The present disclosure describes a multilayer coating, comprising at least one metal oxide layer; and a composite layer provided on said metal oxide layer, said composite layer comprising at least one metal layer disposed between at least two barrier layers, and wherein said barrier layers are substantially impermeable to oxygen. The multilayer coating may be useful as transparent heat reflectors on glass, plastic, and on low temperature processing transparent substrate for energy saving application.

### TECHNICAL FIELD

The present invention relates to a multilayer coating, method for preparing the multilayer coating and uses of the same.

### BACKGROUND ART

A transparent heat reflector (THR) is a multilayer coating structure comprising a thin metal layer sandwiched between dielectrics that may be used for energy-saving application. In cold climates, the transparent heat reflector reflects re-radiated heat from indoor heating systems back into the indoor environment. On the other hand, in hot climates, the transparent heat reflector reflects infra-red (IR) radiation from sunlight. This improves heating or cooling efficiency, conserves more energy and leads to energy saving. Conventionally, low emissivity or heat reflecting coating on glass is prepared by depositing layers of a dielectric/metal/dielectric on the glass substrate.

Currently, the metal layer of most heat reflectors in low thermal emissivity (low-e) coatings is made of silver (Ag) due to its color neutrality. Additionally, gold (Au) exhibits optimum reflectivity spectrum of low-e glass and is also a material of choice in the manufacture of heat reflectors. However, the potential of using gold and silver in the manufacture of heat reflectors is greatly reduced due to their high price.

In the heat reflectors, the number of dielectric layers on the metal can be multilayers. Generally, a metal oxide is used as a dielectric layer. The metal oxides are deposited using metal as a target in ambient oxygen by conventional sputter deposition system on the metal layer. Consequently, low emissivity glass prepared by such conventional methods suffers in terms of performance and stability due to a formation of a thin interfacial oxide layer in between the metal and the dielectric layer. The interfacial oxide layer significantly reduces the performance of the low-emission glass. To overcome the above problem, thin metal layers particularly nickel-chromium (NiCr) alloy or metal nitride have been introduced, however, this results in an increase in the overall thickness of the metal layer, resulting in poor visible light transmittance and heat reflection.

In another approach to make the low-emission glass, the dielectric layer was deposited using metal oxide targets instead of metal targets. The deposition of the dielectric layer on the low emissivity film (metal layer) using metal oxide targets is usually done in an ambient inert gas environment. However, even by using metal oxide targets, the low emissivity film can also be partially oxidized due to the presence of residual oxygen in the chamber and some oxygen radicals from the targets. Moreover, there are some dielectric materials in which oxygen diffuses easily. Thus, during the growth or deposition of dielectrics on the low-emissive layer, oxygen can diffuse into the low-emissive layer and form an interfacial layer. Furthermore, having a thick dielectric directly on the metal layer also reduces the durability of the low emissive layer.

There is therefore a need to provide a multilayer coating that overcomes or at least ameliorates, one or more of the disadvantages described above.

### SUMMARY

According to an aspect, there is provided a multilayer coating, comprising: (a) at least one metal oxide layer; and, (b) a composite layer provided on said metal oxide layer, said composite layer comprising at least one metal layer disposed between at least two barrier layers, and wherein said barrier layers are substantially impermeable to oxygen.

Advantageously, the barrier layer functions as an oxygen diffusion barrier layer between the metal layer and the metal oxide layer. This serves to improve the stability of the multilayer coating when used as a transparent heat reflector. By using the barrier layer, the problem of the metal layer being oxidized when the metal oxide layer is introduced is overcome.

Advantageously, the barrier layer may be deposited onto the metal layer as a uniform layer. The uniformity of the barrier layer may aid in the homogenous growth of the subsequent metal oxide layer on the barrier layer. This may aid in maintaining the stability and properties of the multilayer coating for a prolonged period of time.

In another aspect, there is provided a method for preparing a multilayer coating, the method comprising the steps of: (a) providing a metal layer; (b) depositing a barrier layer on the metal layer, wherein the barrier layer is substantially impermeable to oxygen; and, (c) depositing a transition metal oxide layer on the metal layer covered with the barrier layer.

In another aspect, there is provided use of the multilayer coating described herein as a transparent heat reflector coating on glass, plastic and other low temperature processing transparent substrates.

### DEFINITIONS

The following words and terms used herein shall have the meaning indicated:

The expression “oxygen diffusion barrier layer” may be used interchangeably with “barrier layer”, and for the purposes of this application, refers to any material that is disposed in between two other materials (e.g., materials A and B) to act as a barrier to protect either one of the materials A or B or both from corrosion in the presence of oxygen. In this regard, material A may be the metal layer and material B may be the metal oxide layer.

The word “substantially” does not exclude “completely”. E.g., a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF OPTIONAL EMBODIMENTS

Exemplary, non-limiting embodiments of a multilayer coating will now be disclosed.

The multilayer coating comprises at least one metal oxide layer; and a composite layer provided on said metal oxide layer, said composite layer comprising at least one metal layer disposed between at least two barrier layers, and wherein said barrier layers are substantially impermeable to oxygen.

The metal layer may comprise a metal such as a transition metal. The transition metal may be selected from Group 11, Group 12 or Group 13 of the Periodic Table of Elements. The transition metal may be selected from the group consisting of copper, gold, silver, aluminium, zinc and mixtures thereof. The metal layer may be one that has low emissivity, excellent heat reflecting properties and/or optically transparent at least to visible light.

The metal layer may have a thickness in the range of about 8 nm to 30 nm, wherein the thickness may be about 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm or 30 nm.

The material selected for the barrier layer may have the ability to act as a barrier layer in between two materials (e.g., materials A and B) to protect either one or both materials A and B from corrosion in the presence of oxygen. Hence, the barrier layer may also be termed as an oxygen diffusion barrier layer. Hence, the barrier layer may be inert to corrosion, at least in the presence of oxygen. The barrier layer may be inert to either material A or material B or both such that there is no physical or chemical change to any of the barrier layer, material A or material B when the barrier layer material is brought into contact with either material A or material B or both. In this regard, material A may be the metal layer and material B may be the metal oxide layer of the multilayer coating.

The material for the barrier layer may be an oxide. The oxide may be an oxide of an element selected from Group 4, Group 11, Group 12, Group 13 or Group 14 of the Periodic Table of Elements. The element may be selected from the group consisting of aluminium, zinc, silicon, titanium and mixture thereof. The barrier layer may comprise aluminium oxide (Al₂O₃).

The barrier layer may have a thickness in the range of about 1.0 nm to about 5.0 nm, about 1.0 nm to about 4.0 nm, about 1.0 nm to about 3.0 nm, about 1.0 nm to about 2.0 nm, about 2.0 nm to about 5.0 nm, about 3.0 nm to about 5.0 nm, about 4.0 nm to about 5.0 nm, about 2.0 nm to about 3.0 nm. The thickness of the barrier layer may be about 2 nm.

The metal oxide layer of the multilayer coating may be an oxide of a transition metal. The transition metal may be selected from the group consisting of zirconium, tantalum, niobium, titanium, hafnium, tin, tungsten, molybdenum and mixtures thereof. The metal oxide layer in the multilayer coating may be a zirconium oxide layer. The metal oxide layer may be a dielectric material.

The metal oxide layer may have a thickness in the range of about 10 nm to about 100 nm, about 10 nm to about 30 nm, about 10 nm to about 40 nm, about 10 nm to about 50 nm, about 10 nm to about 60 nm, about 10 nm to about 70 nm, about 10 nm to about 80 nm, about 10 nm to about 90 nm, about 30 nm to about 100 nm, about 40 nm to about 100 nm, about 50 nm to about 100 nm, about 60 nm to about 100 nm, about 70 nm to about 100 nm, about 80 nm to about 100 nm, about 90 nm to about 100 nm, or about 40 nm to about 80 nm.

The metal oxide layer of the multilayer coating may have good adhesive, anti-reflection and anti-scratch properties. The thickness of the metal oxide layer may be larger than those of the metal layer and the barrier layer. Therefore, it is important that this coating has excellent heat reflecting properties and maintains high transparency to visible light. Further, the metal oxide layer may function as an adhesive layer to enable the multilayer coating to be attached firmly to a substrate. Hence, the metal oxide layer may be capable of engaging with a substrate to be coated.

The multilayer coating in the present disclosure may have excellent transparency to visible light in the sense that visible light may be transmitted across the multilayer coating to the substrate that the multilayer coating is coated on. The transparency of the multilayer coating may be measured using UV-Vis spectrometry. The transparency of the multilayer coating for visible light may be at least 30%, 40%, 50%, 60%, 70% or at least 80%.

The multilayer coating may maintain excellent transparency to visible light, after at least 1 month, 2 months, 3 months, 4 months, 5 months or 6 months and above of fabrication. The transparency of the multilayer coating, after the above-mentioned durations, as measured using UV-Vis spectrometry may be at least 30%, 40%, 50%, 60%, 70% or at least 80%.

The multilayer coating in the present disclosure may maintain excellent transparency to visible light, after thermal treatment at a high temperature of about 100° C. for about 6 hours. The transparency of the multilayer coating, after said thermal treatment, as measured using UV-Vis spectrometry may be at least 30%, 40%, 50%, 60%, 70% or at least 80%. Hence, the multilayer coating may be stable after thermal treatment.

The multilayer coating in the present disclosure may maintain excellent transparency to visible light, after annealing at a temperature of at least 300° C., 400° C., 500° C. or 600° C. The transparency of the multilayer coating, after annealing at the above temperature, as measured using UV-Vis spectrometry, may be at least 30%, 40%, 50%, 60%, 70% or at least 80%.

The multilayer coating in the present disclosure has been developed under ambient conditions. Thus it may work suitably well with transparent substrates such as, but are not limited to, materials that require low temperature processing (low thermal budget). Transparent substrates that may be suitable to work with the multilayer coating may comprise glass, plastics, quartz and diamond and any mixtures thereof.

The thickness of the metal layer and the dielectric layer may be substantially varied to control the amount of heat reflection and transparency in the multilayer coating. For example, the thickness of the metal layer may be 20 nm; while the thickness of the dielectric layer may be, but not limited to, 40 nm, 45 nm, 50 nm, 55 nm, 60 nm, 65 nm, 70 nm, 75 nm or 80 nm. In another example, the thickness of the dielectric layer may be 80 nm; while the thickness of the metal layer may be, but not limited to, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm or 30 nm.

The multilayer coating may comprise additional layers of the metal oxide layer, wherein each additional metal oxide layer may be made from the same or different material as the preceding metal oxide layer. Hence, the multilayer coating may have one layer of the metal layer, at least two barrier layers disposed on both sides of the metal layer, and at least two metal oxide layers on the exposed surfaces of the barrier layers. Hence, the multilayer coating may have at least five layers (of the metal layer, the metal oxide layers and the barrier layers) or at least seven layers (with two additional metal oxide layers). It is to be noted that the number of multi-layers is not limited to the above and may be any number of layers as required as long as the transmittance and reflectance of the multilayer coating is not compromised. Further, given these conditions are met, the number of metal oxide layers can be increased to enhance the functionalities of the multilayer coating such as self-cleaning and anti-bacterial protection.

The multilayer coating as defined above may be used to make a transparent heat reflector coating on glass, plastic and other low temperature processing transparent substrates for energy saving application.

Exemplary, non-limiting embodiments of a method for making a multilayer coating will now be disclosed.

The method of preparing a multilayer coating may comprise the steps of: (a) providing a metal layer, (b) depositing a barrier layer on the metal layer, wherein the barrier layer is substantially impermeable to oxygen, and (c) depositing a transition metal oxide layer on the metal layer covered with the barrier layer. The multilayer coating, including metal and metal oxides, can be prepared by physical vapor deposition such as sputter, thermal evaporation, electron beam evaporation and chemical vapor deposition such as atomic layer deposition. Thin film metal can be deposited by sputtering of metal targets (of purity 99.99%) in ambient argon. The thickness of the metal can be adjusted by varying the sputtering power, the working pressure and the duration of sputter. Metal oxides on and below the barrier layer can be deposited by sputtering of metal oxide targets (of purity ˜99.99%). The thickness, the refractive index, and the bandgap of the metal oxides can be controlled during the sputtering of a single metal oxide target and/or a mixture of targets and by varying the sputtering conditions.

The barrier layer may be deposited on the metal layer by sputtering metal targets in an oxygen atmosphere for a short duration. The barrier layer may be deposited on the metal layer by sputtering of metal oxide targets in an ambient inert atmosphere such as argon.

The metal oxide layer may be deposited on the metal layer covered with the barrier layer by sputtering of metal targets in an ambient inert atmosphere. The metal oxide layer may be deposited on the metal layer covered with the barrier layer by sputtering of metal oxide targets in an ambient inert atmosphere.

The ambient inert atmosphere may be provided using nitrogen gas, argon gas or any mixture thereof.

### BRIEF DESCRIPTION OF DRAWINGS

The accompanying drawings illustrate a disclosed embodiment and serves to explain the principles of the disclosed embodiments. It is to be understood, however, that the drawings are designed for purposes of illustration only, and not as a definition of the limits of the invention.

FIG. 1

[FIG. 1] refers to a schematic diagram of a Cu and ZrO₂ based multilayer coating on glass substrate as described in Example 1.

FIG. 2

[FIG. 2] refers to the UV-vis spectra of the heat reflector of FIG. 1 after thermal treatment at different temperatures for 1 minute with the thickness of Cu and ZrO₂ being 20 nm and 40 nm respectively, in which (a) refers to the full spectra taken from 300 nm to 2300 nm and (b) is an enlargement of the full spectra wherein the wavelength is from 300 nm to 900 nm.

FIG. 3

[FIG. 3] refers to the transmission spectra of the heat reflector of FIG. 1 after thermal treatment at different temperatures for 1 minute with the thickness of Cu and ZrO₂ being 30 nm and 80 nm respectively in which (a) refers to the full spectra taken from 300 nm to 2300 nm and (b) is an enlargement of the full spectra wherein the wavelength is from 300 nm to 900 nm.

FIG. 4

[FIG. 4] refers to a schematic diagram of a Cu and ZrO₂ based heat reflector on a glass substrate with an Al₂O₃ oxygen diffusion barrier as discussed in Example 2.

FIG. 5

[FIG. 5] refers to the transmission spectra of the heat reflector of FIG. 4 after thermal treatment at different temperatures for 1 minute with the thickness of Cu, ZrO₂ and Al₂O₃ being 20 nm, 40 nm and ˜2 nm respectively.

FIG. 6

[FIG. 6] refers to the transmission spectra of a ZrO₂/Cu/ZrO₂ multilayer coating immediately after coating deposition, after 6 months of the coating deposition, and after thermal treatment at 100° C. for 6 hours with the thickness of Cu and ZrO₂ being 40 nm and 20 nm respectively in which (a) refers to the full spectra taken from 300 nm to 2300 nm and (b) is an enlargement of the full spectra wherein the wavelength is from 300 nm to 900 nm.

FIG. 7

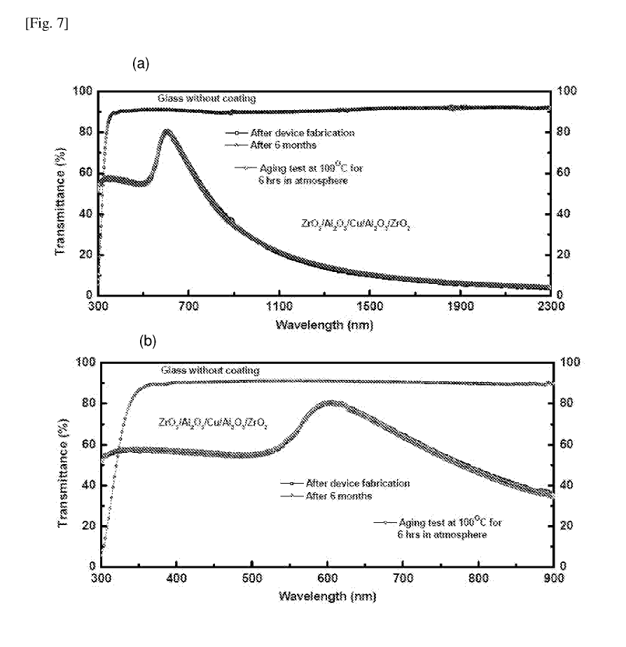

[FIG. 7] refers to the transmission spectra of a ZrO₂/Al₂O₃/Cu/Al₂O₃/ZrO₂ multilayer coating immediately after coating deposition, after 6 months of the coating deposition, and after thermal treatment at 100° C. for 6 hours with the thickness of Cu, Al₂O₃ and ZrO₂ being 40 nm, 2 nm and 20 nm respectively in which (a) refers to the full spectra taken from 300 nm to 2300 nm and (b) is an enlargement of the full spectra wherein the wavelength is from 300 nm to 900 nm.

### EXAMPLES

Non-limiting examples of the invention will be further described in greater detail by reference to specific examples, which should not be construed as in any way limiting the scope of the invention.

### Example 1: Cu and ZrO₂ Based Multilayer Coating

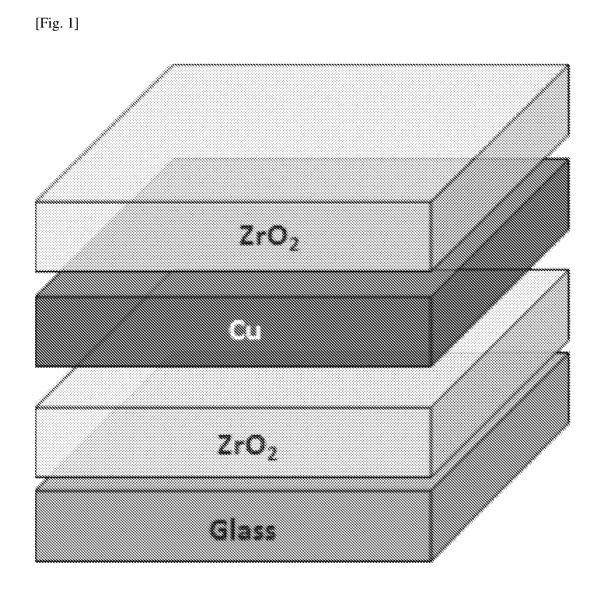

A multilayer coating having two symmetrical metal oxide layers with identical thickness on and below a metal layer has been proposed to maximize the visible transmittance of the multilayer coating. In this example, the metal oxide layers were made from zirconium oxide and the metal layer was a copper layer. By changing the thickness of Cu and ZrO₂ layer, visible transmittance and heat reflecting properties of the multilayer coating (hereby termed as a heat reflector coating or heat reflector) can be tuned. A schematic diagram of the structure of such a Cu and ZrO₂ based heat reflector is seen in FIG. 1.

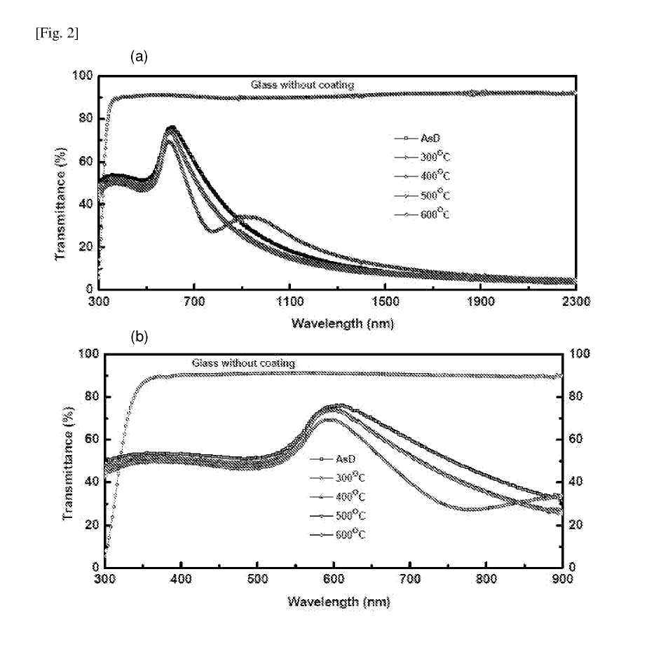

For example, a multilayer coating of ZrO₂/Cu/ZrO₂ thin film was deposited using sputter deposition technique at room temperature. Pure copper (purity of ˜99.99% purchased from Kurt J. Lesker Company, USA) and stoichiometric ZrO₂ targets (purity of ˜99.99% purchased from Kurt J. Lesker Company, USA) were used to sputter the ZrO₂/Cu/ZrO₂ multilayer thin film on glass or any transparent substrate. The deposition of the multilayers was performed sequentially without breaking the vacuum. The RF power was maintained at ˜150 W to sputter the ZrO₂ until the required thickness is obtained and the DC power was held at 100 W to deposit the copper metal layer. Argon gas flow rate was kept constant at 25 sccm and the deposition was done at a working pressure of 3.3 mTorr. To improve the metal oxide quality of the multilayer coating, annealing was done at different temperatures in nitrogen ambient for 1 minute with heating and cooling rate of 10° C./sec by using rapid thermal processing (RTP) system, Jet First 150 (Jipelec). The sputtering power and the working pressure can be adjusted to improve the performance of the coating. FIG. 2 provides the UV-Vis spectra (transmission) of the above heat reflector after thermal treatment at different temperatures for 1 minute wherein the thickness of Cu and ZrO₂ was 20 nm and 40 nm respectively. FIG. 2(a) provides the full spectra taken from 300 nm to 2300 nm while FIG. 2(b) is an enlargement of the full spectra wherein the wavelength is from 300 nm to 900 nm. The spectra compare the transparency of glass when it is coated with the ZrO₂/Cu/ZrO₂ multilayer coating and when it is not.

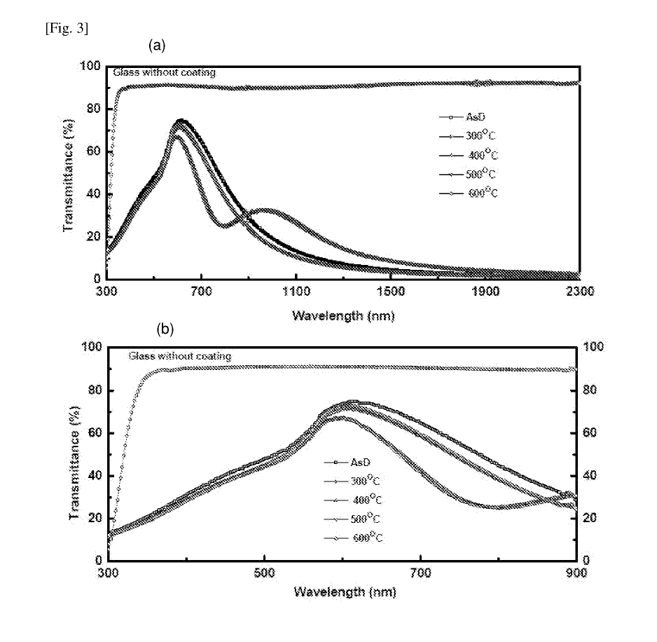

FIG. 3 provides the UV-Vis spectra (transmission) of the heat reflector after thermal treatment at different temperatures for 1 minute wherein the thickness of Cu and ZrO₂ as 30 nm and 80 nm respectively. FIG. 3(a) provides the full spectra taken from 300 nm to 2300 nm and FIG. 3(b) is an enlargement of the full spectra wherein the wavelength is from 300 nm to 900 nm. The spectra compare the transparency of glass when it is coated with the ZrO₂/Cu/ZrO₂ multilayer coating and when it is not.

The spectra in FIG. 2(a), FIG. 2(b), FIG. 3(a) and FIG. 3(b) indicate that by changing the thickness of Cu and ZrO₂ in the heat reflector, the visible transmittance and heat reflecting property can be altered. As can be seen from the figures, as the thickness of the zirconium oxide layer increases, the transmittance of the heat reflector decreases, leading to an inverse relationship between the thickness of the zirconium oxide layer and the transmittance of the heat reflector.

### Example 2: Cu, Al₂O₃ and ZrO₂ Based Multilayer Coating

In this example, the multilayer coating comprise two metal oxide layers made from zirconium oxide, a metal layer such as a copper layer and two barrier layers made from aluminium oxide that were disposed between the metal layer and the respective metal oxide layers. The aluminium oxide layer functioned as an oxygen diffusion barrier layer to enhance the visible transmission durability of transparent heat reflector (THR) without sacrificing heat reflection.

Here, the thickness of the aluminium oxide was about 2 nm to 3 nm and may be used to block oxygen diffusion through the heat reflector such that an interfacial layer (that may be formed in conventional heat reflectors when a metal oxide layer is deposited directly onto a metal layer) between the copper layer and the zirconium oxide layer is substantially minimised or eliminated. Hence, the problems associated with conventional heat reflectors may be overcome by adding a barrier layer between the two layers. The barrier layer may aid in reducing the corrosion of the metal layer or metal oxide layer or both.

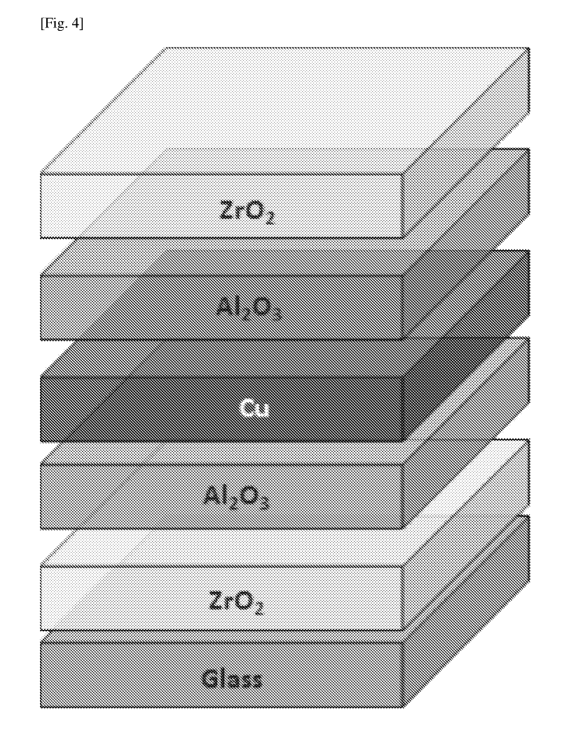

The thin film Al₂O₃ layer can be deposited onto the copper layer by sputtering using an Al₂O₃ target of purity ˜99.99% purchased from Kurt J. Lesker Company. It is also possible to deposit a thin film of aluminium metal onto the copper layer and then allowing that aluminium thin film to oxidise. FIG. 4 is a schematic diagram of the heat reflector of this example showing the various layers, in which the copper layer is between two layers of aluminium oxide, which is in turn sandwiched between two layers of zirconium oxide.

Visible transmittance increased by about 8% with no change in the heat reflection property of the heat reflector (data not shown). In addition, as the thin film Al₂O₃ provided a uniform surface on the copper layer, the growth of the zirconium oxide layer (or layers) was homogeneous. In this manner, the stability of the heat reflecting properties of the heat reflector can be maintained for a longer duration.

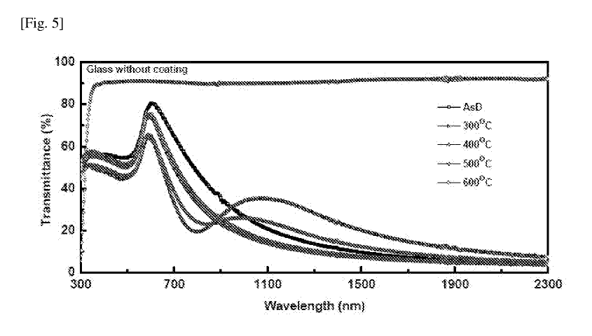

FIG. 5 provides the UV-Vis spectra (transmission) of the heat reflector after thermal treatment at different temperatures for 1 minute wherein the thickness of Cu, ZrO₂ and Al₂O₃ is 20 nm, 40 nm and 2 nm respectively. FIG. 5 provides the full spectra taken from 300 nm to 2300 nm. The spectra compare the transparency of glass when it is coated with the ZrO₂/Al₂O₃/Cu/Al₂O₃/ZrO₂ multilayer coating and when it is not.

### Example 3: Stability of a Cu and ZrO₂ Based Multilayer Coating

The optical characteristics of the ZrO₂/Cu/ZrO₂ multilayer coating (from Example 1) were analysed using UV-Vis spectrometry immediately and after 6 months of fabrication. Furthermore, the optical characteristics of the multilayer coating after thermal treatment at 100° C. for 6 hours in the atmosphere were analysed using UV-Vis spectrometry.

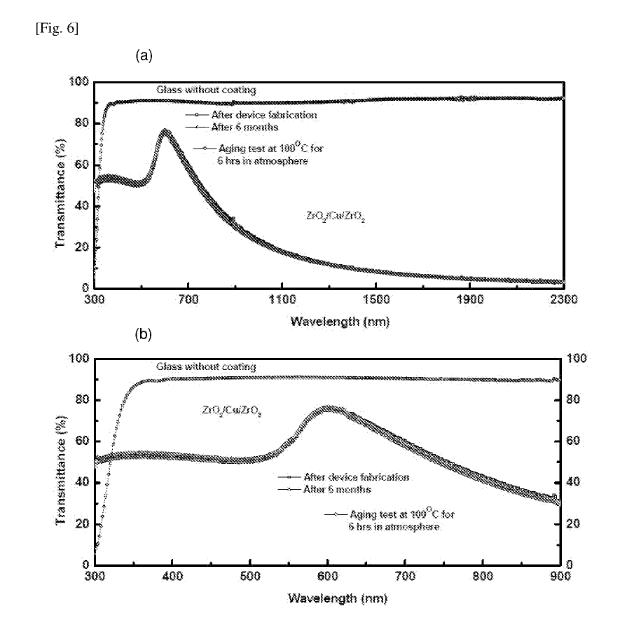

FIG. 6 provides the UV-Vis spectra (transmission) of the ZrO₂/Cu/ZrO₂ multilayer coating immediately after coating deposition, after 6 months of the coating deposition, and after thermal treatment at about 100° C. for 6 hours, wherein the thickness of Cu and ZrO₂ was 40 nm and 20 nm respectively. FIG. 6(a) provides the full spectra taken from 300 nm to 2300 nm and FIG. 6(b) is an enlargement of the full spectra wherein the wavelength is from 300 nm to 900 nm. The spectra compare the transparency of glass when it is coated with the ZrO₂/Cu/ZrO₂ multilayer coating and when it is not.

The results in FIG. 6(a) and FIG. 6(b) thus show that there is no change in the optical properties (UV-Vis transmission and infrared reflection), indicating that the ZrO₂/Cu/ZrO₂ multilayer coating is robust and ambient stable.

### Example 4: Stability of a Cu, Al₂O₃ and ZrO₂ Based Heat Reflector

The optical characteristics of the ZrO₂/Al₂O₃/Cu/Al₂O₃/ZrO₂ multilayer coating (from Example 2) were analysed using UV-Vis spectrometry immediately and after 6 months of fabrication. Furthermore, the multilayer coating after thermal treatment at about 100° C. for 6 hours in the atmosphere was analysed using UV-Vis spectrometry.

FIG. 7 provides the UV-Vis spectra (transmission) of the ZrO₂/Al₂O₃/Cu/Al₂O₃/ZrO₂ multilayer coating immediately after coating deposition, after 6 months of the coating deposition, and after thermal treatment at about 100° C. for 6 hours, wherein the thickness of Cu, Al₂O₃ and ZrO₂ was 40 nm, 2 nm and 20 nm respectively. FIG. 7(a) provides the full spectra taken from 300 nm to 2300 nm and FIG. 7(b) is an enlargement of the full spectra wherein the wavelength is from 300 nm to 900 nm. The spectra compare the transparency of glass when it is coated with the ZrO₂/Al₂O₃/Cu/Al₂O₃/ZrO₂ multilayer coating and when it is not.

The results in FIG. 7(a) and FIG. 7(b) thus show that there is no change in the optical properties (UV-Vis transmission and infrared reflection), indicating the ZrO₂/Al₂O₃/Cu/Al₂O₃/ZrO₂ multilayer coating is robust and ambient stable.

### INDUSTRIAL APPLICABILITY

In the present disclosure, the multilayer coating may be useful as transparent heat reflectors on glass, plastic, and on low temperature processing transparent substrate for energy saving application. Hence, the multilayer coating may be used on windows on buildings or automobiles, or on screens on electronic devices, as well as devices that require anti-scratch and wear resistance properties, leading to multiple applications in the construction, automobile or electronic industries.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1-12. (canceled)

13. A multilayer coating, comprising:
a. at least one metal oxide layer; and,
b. a composite layer provided on said metal oxide layer, said composite layer comprising at least one metal layer disposed between at least two barrier layers, and wherein said barrier layers are substantially impermeable to oxygen; and,
c. wherein the thickness of the metal layer is in the range of 15 nm to 30 nm.

14. The multilayer coating according to claim 13, wherein the barrier layer is an oxide of an element selected from Group 4, Group 11, Group 12, Group 13 or Group 14 of the Periodic Table of Elements.

15. ; The multilayer coating according to claim 14, wherein the element of the oxide is selected from the group consisting of aluminium, zinc, silicon, titanium and mixtures thereof.

16. The multilayer coating according to claim 13, wherein the barrier layer is aluminium oxide,

17. The multilayer coating according to claim 13, wherein the thickness of the barrier layer is in the range of 1 nm to 5 nm.

18. The multilayer coating according to claim 13, wherein the metal layer comprises a metal selected from Group 11, Group 12 or Group 13 of the Periodic Table of Elements.

19. The muiltilayer coating according to claim 18, wherein the metal is selected from the group consisting of copper, gold, silver, aluminium, zinc and mixtures thereof.

20. The multilayer coating according to claim 13, wherein the metal oxide layer is an oxide of a transition metal selected from the group consisting of zirconium, tantalum, niobium, titanium, hafnium, tin, tungsten, molybdenum and mixtures thereof.

21. The multilayer coating according to claim 13, wherein the thickness of the metal oxide layer is in the range of 40 nm to 100 nm.

22. A method of preparing a multilayer coating, the method comprising:
a. providing a metal layer, wherein the thickness of the metal layer is in the range of 15 nm to 30 nm;
b. depositing a barrier layer on the metal layer, wherein the barrier layer is substantially impermeable to oxygen;
c. depositing a transition metal oxide layer on the metal layer covered with the barrier layer.

23. A method of using a multilayer coating as a transparent heat reflector coating on glass, plastic and other low temperature processing transparent substrates, wherein the multilayer coating comprises:
a. at least one metal oxide layer; and,
b. a composite layer provided on said metal oxide layer, said composite layer comprising at least one metal layer disposed between at least two barrier layers, and wherein said barrier layers are substantially impermeable to oxygen; and,
c. wherein the thickness of the metal layer is in the range of 15 nm to 30 nm.
